(19) United States
(12) Patent Application Publication
(10) Pub. No.: US 2002/0155206 A1
(43) Pub. Date: Oct. 24, 2002

(54) Soy-based pasta

(76) Inventor: Carlo Orlando, Maywood, NJ (US)

Correspondence Address: SCHWEITZER CORNMAN GROSS & BONDELL LLP, 292 Madison Avenue, 19th Floor, New York, NY, 10017, US

(21) Appl. No.: 09/780,914

(22) Filed: Feb. 9, 2001

(51) Int. Cl. A21D 13/04

(52) U.S. Cl. 426/550

(57) ABSTRACT

A high protein soy-based pasta having a consistency especially suited for forming it into pasta such as spaghetti and fusilli. At least half of the dried product, based on weight, is soy flour. The pasta is low in fat and carbohydrates and high in protein. It may be prepared into tasty dishes with the use of little or no additional fat.

### FIELD OF THE INVENTION

The present invention relates generally to high protein foods and specifically to a novel soy-based pasta that is rich in amino acids, low in carbohydrates, and very low in fat.

### BACKGROUND OF THE INVENTION

Protein is a vital component of every healthful diet for many well-known reasons, including strengthening the immune system and providing the body with sustained energy. Many people rely on meat (red meat, white meat, and fish) to provide a large portion of the protein in their daily diets. Although these foods are high in protein, they often also contain fat—saturated as well as unsaturated—and are typically prepared with additional fat such as oil and butter. This may be a problem for dieters who try to reduce their fat consumption, especially dieters who have high cholesterol and try to reduce their consumption of saturated fat.

Many dieters continue to eat meat on a regular basis but usually eliminate the fattier cuts and prepare it with little or no additional fat. Unfortunately, there are few ways to prepare lean cuts of meat into tasty dishes without using additional fat. There are still fewer ways to prepare meat for dieters who must reduce their fat intake more drastically. These dieters range from heart attack victims to athletes such as gymnasts, both who try to cut back considerably on their fat intake while simultaneously trying to sustain or even increase their protein intake. Thus it is inconvenient only to eat meals that are high in protein and very low in fat, and the limited number of such meals results in eating the same foods over and over again.

Drawbacks may accompany the undertaking of a more drastic diet. For example, dieters who are permitted to eat little or no meat may lower not only their fat intake but also their protein consumption, potentially depriving their bodies of much needed protein. Dieters who prepare meat using less fat often do not stick to their diets for the long term because their meals generally have less taste and are less appealing. Dieters who choose to eat only very lean cuts of meat may end up spending more money for their food, and the very lean cuts may not have as much taste as the fattier cuts. Dieters who take pills that prevent a portion of the fat consumed from being metabolized by the body may suffer adverse side effects. Thus there is a need for a way to reduce one's fat and cholesterol intake considerably without cutting back on protein consumption and without taking the enjoyment out of eating.

One healthful way to reduce or altogether eliminate the quantity of meat consumed is to substitute meat with an alternate protein source that is low in fat and cholesterol. Unfortunately, the number of non-meat protein sources is limited—especially the number of protein sources simultaneously having the nutrition found in meat.

One alternate protein source is the legume. Legumes have long been eaten by vegetarians to provide them with protein and nutrition otherwise obtained from eating meat. Legumes encompass plants such as peas, black-eyed peas, kidney beans, navy beans, chick peas, and soybeans—plants that are especially high in protein. The most versatile of the legumes is perhaps the soybean. Soybeans may be used to prepare soy milk, which is higher in protein than dairy milk. Soy milk may be used to prepare tofu, a well known food that can be prepared in a large variety of ways with using little or no additional fat.

The protein from the soybean is complete, the only such protein found in a plant. It has all 18 essential amino acids, including all of the amino acids the body does not produce but can only get from food. Soy protein is also a source of phytochemicals, some of which have been found to be particularly healthful by helping to prevent chronic diseases and conditions. One group of phytochemicals found in the soybean is isoflavones, including genistein, daidzen, and glycitein, which have been found to provide health benefits such as reducing the risk of some cancers, cardiovascular disease, and osteoporosis, as well as reducing menopausal symptoms.

As more people are discovering the benefits of the soybean, manufacturers are developing new ways to incorporate the soybean into their foods. Manufacturers have begun to add soy protein concentrate, isolated soy protein, and/or soy flour to many foods including cheese, yogurt, and baking mix. Soy protein concentrate, which is 70% protein based on dry weight, is made by processing soy flakes to remove some of the sugar that naturally occurs in soy. One way to make the concentrate is to add alcohol to soy flakes to dissolve sugars and other alcohol-soluble substances. Unfortunately, preparing the concentrate often removes many of the isoflavones naturally present in the soybean. Isolated soy protein, which is 90% protein based on dry weight, is first manufactured by using water to remove most of the sugar in the soy flakes, then by precipitating and drying the protein. Isolated soy protein is popular as a powder protein supplement, which may be added to and dissolved in liquid. Soy flour, which is 50% protein based on dry weight, is ground from soy flakes to the desired particle size.

Because soy protein concentrate and isolated soy protein generally must be added to other foods, someone who wants the protein and nutrition from the soybean without simultaneously consuming the ingredients of the other food has a limited number of choices. Traditionally the choices have included eating soybeans whole, eating tofu, and drinking soy milk. Thus it would be beneficial if there were additional options of soy-based foods that do not need to be added to a separate food to be consumed.

### SUMMARY OF THE INVENTION

The present invention provides an additional option for someone who wants a soy-based food that does not need to be added to a separate food to be consumed. The novel soy-based food of the present invention is a pasta made substantially of soy flour and is therefore high in protein. The protein is complete, containing all 18 essential amino acids. The soy-based pasta of the present invention may have shapes ranging from linguine to penne. The soy-based pasta is easily prepared into a variety of tasty meals without using additional fat.

The present soy-based pasta is beneficially low in carbohydrates for dieters who try to reduce their carbohydrate intake while increasing their protein intake. Thus these dieters may eat a food item (pasta) that they otherwise may need to avoid. The soy-based pasta has 80% less assumable carbohydrates that normal pasta. All the carbohydrates are complex rather than simple and are therefore less likely to be converted into fat by the body. The novel soy-based pasta is low in polyunsaturated fat and extremely low in saturated fat and no cholesterol. It is rich in fiber, thus reducing the risk of some cancers and reducing the absorption of some fat organisms and carbohydrates.

### DETAILED DESCRIPTION OF THE INVENTION

The present invention is a soy-based pasta whose consistency is especially suited for forming it into any pasta shape, from spaghetti to fusilli. It has been found that combining soy flour with a glutinous flour, a farinaceous flour, and a liquid ingredient such as eggs or egg whites, wherein at least half of the mixture is soy flour, produces a mixture that is very easily formed into pasta shapes and then dried by drying methods well known in the art of pasta making. The amount of soy flour is preferably as high as 75% of the dried product. Thereafter, the pasta may be cooked as a tasty dish simply by cooking it in boiling water.

Because the pasta contains soy flour as opposed to soy isolate, it has the nutrients of soy flour that are otherwise removed from the soybean in the making of soy isolate. The amount of flour other than soy flour is very low in order to reduce the amount of carbohydrates in the product.

The soy-based mixture preferably contains ingredients in the following ranges:

| | |
|---|---|
| soy flour | 57.5%-80% |
| egg whites | 2.5-6.0% (after the drying process) |
| durum wheat semolina | 7.5%-10% |
| gluten | 7.5%-10% |
| vegetable protein | 0%-2.5%. |

The following ingredients were blended and submitted to a lab, yielding the results of Table I:

| | |
|---|---|
| soy flour | 75% |
| egg whites | 2.5% |
| durum wheat | 10% |
| gluten | 10% |
| vegetable protein | 2.5%. |

TABLE I

| | |
|---|---|
| Calories | 1237 KJ/100 g |
| Calories | 291 Kcal/100 g |
| Fat | 1.81 g/100 g |
| Saturated Fat | 0.49 g/100 g |
| Unsaturated Fats | (Too small to be determined) g/100 g |
| Cholesterol | 0.879 mg/100 g |
| Protein | 50.2 g/100 g |
| Carbohydrates | 18.6 g/100 g |
| Saccharose | 4.95 g/100 g |
| Maltose | 0.23 g/100 g |
| Lactose | Too small to be determined (g/100 g) |
| Glucose | 0.13 g/100 g |
| Fructose | 0.10 g/100 g |
| Natural Fibers | 12.5 g/100 g |
| Sodium | 85.5 mg/100 g |
| Calcium | 245 mg/100 g |
| Iron | 11.5 mg/100 g |
| Water Content | 12.3 g/100 g |
| Ash | 4.61 g/100 g |
| Shelf Life | 18-20 month |

While preferred embodiments of the soy-based pasta of the present invention have been disclosed for illustrative purposes, those who are skilled in the art will appreciate that various modifications, additions and substitutions to the mixture are possible without departing from the scope and spirit of the soy-based pasta as set forth in the accompanying claims.

I claim:

1. A method for preparing a high protein pasta that is low in both carbohydrates and fat, comprising:
(a) combining soy flour, farina, gluten, and a fluid ingredient, wherein the weight percentage of soy flour out of the four said ingredients is at least 50%.

2. The method of claim 1, wherein said pasta is then formed into a desired shape.

3. The method of claim 2, wherein the pasta is then dried.

4. The method of claim 2, wherein the weight percentage of soy flour out of the four ingredients is at least 55%.

5. The method of claim 3, wherein said fluid ingredient is eggs.

6. The method of claim 3, wherein said fluid ingredient is egg whites.

7. The method of claim 3, wherein the farina is durum wheat semolina.

8. The method of claim 3, wherein the gluten is gum gluten from wheat.

9. The method of claim 3, wherein the soy flour is full fat.

10. The method of claim 1, wherein a vegetable protein is also added to the pasta.

11. The method of claim 10, wherein said liquid ingredient is egg whites, the soy flour is full fat, the farina is durum wheat semolina, and the gluten is gum gluten from wheat, wherein the weight percentage of each ingredient is:

| | |
|---|---|
| soy flour full fat | 75% |
| egg whites | 2.5% |
| durum wheat semolina | 10% |
| gum gluten from wheat | 10% |
| vegetable protein | 2.5%; |

wherein sufficient egg white is added to the mixture to provide 2.5% egg white after the drying process.

12. A high protein pasta that is low in both carbohydrates and fat, comprising:
(a) a combination of soy flour, farina, gluten, and a fluid ingredient, wherein the weight percentage of soy flour out of the four said ingredients is at least 50%.

13. The pasta of claim 12 formed into a desired shape.

14. The pasta of claim 13, wherein the pasta is dried.

15. The pasta of claim 13, wherein the weight percentage of soy flour out of the four ingredients is at least 55%.

16. The pasta of claim 14, wherein said fluid ingredient is eggs.

17. The pasta of claim 14, wherein said fluid ingredient is egg whites.

18. The pasta of claim 14, wherein the farina is durum wheat semolina.

19. The pasta of claim 14, wherein the gluten is gum gluten from wheat.

20. The pasta of claim 14, wherein the soy flour is full fat.

21. The pasta of claim 12 having a vegetable protein as a further ingredient.

22. The pasta of claim 21, wherein said liquid ingredient is egg whites, the soy flour is full fat, the farina is durum wheat semolina, and the gluten is gum gluten from wheat, wherein the weight percentage of each ingredient is:

| | |
|---|---|
| soy flour full fat | 75% |
| egg whites | 2.5% |
| durum wheat semolina | 10% |
| gum gluten from wheat | 10% |
| vegetable protein | 2.5%; |

wherein sufficient egg white is added to the mixture to provide 2.5% egg white after the drying process.
